(19) United States
(12) Patent Application Publication
(10) Pub. No.: US 2009/0184639 A1
(43) Pub. Date: Jul. 23, 2009

(54) Plasma display panel

(76) Inventors: Seung-Uk Kwon, Suwon-si (KR); Young-Soo Seo, Suwon-si (KR); Young-Kuk Kwon, Suwon-si (KR); Ho-Seok Lee, Suwon-si (KR)

Correspondence Address: ROBERT E. BUSHNELL & LAW FIRM, 2029 K STREET NW, SUITE 600, WASHINGTON, DC, 20006-1004, US

(21) Appl. No.: 12/318,696

(22) Filed: Jan. 6, 2009

(30) Foreign Application Priority Data
Jan. 18, 2008 (KR) 10-2008-0005865

(51) Int. Cl. H01J 17/49

(52) U.S. Cl. 313/582

(57) ABSTRACT

A plasma display panel (PDP) including: a pair of substrates facing each other; a plurality of discharge electrodes disposed on inner surfaces of the substrates; a dielectric layer covering the discharge electrodes; and barrier ribs disposed between the substrates to form discharge spaces therebetween, wherein the substrates are partitioned into a display area displaying an image and a non-display area extended from the display area, and the barrier ribs include a plurality of first barrier ribs disposed in the display area and a plurality of second barrier ribs disposed in the non-display area, and the thickness of the dielectric layer in the non-display area in which the second barrier ribs are disposed is smaller than the thickness of the dielectric layer in the display area in which the first barrier ribs are disposed.

### CLAIM OF PRIORITY

This application makes reference to, incorporates the same herein, and claims all benefits accruing under 35 U.S.C. § 119 from an application for PLASMA DISPLAY PANEL earlier filed in the Korean Intellectual Property Office on 18 Jan. 2008 and there duly assigned Korean Patent Application No. 10-2008-0005865.

### BACKGROUND OF THE INVENTION

1. Field of the Invention

The present invention relates to a plasma display panel (PDP), and more particularly, to a plasma display panel having an improved structure to prevent noise which may be generated by collision between a substrate and barrier ribs.

2. Description of the Related Art

In general, plasma display panels (PDPs) are flat display devices in which a discharge gas is injected into a space between two substrates on which a plurality of discharge electrodes are formed, and phosphor materials of a phosphor layer are excited by ultraviolet rays generated by exciting the discharge gas to form desired images such as numbers, letters, or graphics.

Referring to FIG. 1, a conventional three-electrode surface discharge type PDP 100 includes a first substrate 101, a second substrate 102, and a sealing member 103 interposed between the first substrate 101 and the second substrate 102. The PDP 100 is partitioned into a display area displaying an image when the PDP 100 is driven and a non-display area extended from the display area.

Pairs of first discharge electrodes 106 having an X electrode and a Y electrode are disposed on an inner surface of the first substrate 101, and the first discharge electrodes 106 are covered by a first dielectric layer 107, and a protection layer 108 is formed on the surface of the first dielectric layer 107. A second discharge electrode 109, which is an address electrode, is disposed on the inner surface of the second substrate 102, and the second discharge electrode 109 is covered by a second dielectric layer 110.

Barrier ribs 111 are formed between the first substrate 101 and the second substrate 102. The barrier ribs 111 includes a plurality of discharge barrier rib portions 113 disposed in the display area, an outer barrier rib portion 114 connected to the outer side of the discharge barrier rib portions 113 and disposed in the non-display area, and a dummy barrier rib portion 115 disposed in the non-display area. A phosphor layer 112 is formed in the discharge barrier rib portions 113, whereas no phosphor layer is formed on the outer barrier rib portion 114 and the dummy barrier rib portion 115.

In the conventional PDP 100, electrical signals are respectively applied to the Y electrodes of the pairs of first discharge electrodes 106 and the second discharge electrode 109 to select a discharge cell at the crossing point of the Y electrodes and the second discharge electrode 109, and then electrical signals are alternately applied to the pairs of the first discharge electrodes 106, which are sustain discharge electrode, to generate a surface discharge from a surface of the first substrate 101. Thus ultraviolet rays are generated, and visible light is emitted from the phosphor layer 112 coated inside the selected discharge cell, thereby realizing a static or moving image.

However, in the conventional PDP 100, while the PDP 100 is driven or manufactured, noise is caused as an upper end of the outer barrier rib portion 114 or an upper end of the dummy barrier rib portion 115 collides against the first substrate 101.

Noise is caused mainly because the outer barrier rib portion 114 or the dummy barrier rib portion 115 is deformed while they are fired, and this causes irregularity in their height.

In other words, after the barrier ribs 111 are patterned with desired patterns using a sand blast method, a press method, or a photosensitive method, the barrier ribs 111 are fired at a temperature of 450° C. or greater. The barrier ribs 111 are fired in order to burn impurities included in the raw material for forming barrier ribs, or unnecessary binders, in order to strengthen the barrier ribs 111.

However, when the binders are fired, the barrier ribs 111 contract. In particular, as illustrated in FIG. 2, a greater contraction force is applied to a predetermined area of the outer barrier rib portion 114 or the dummy barrier rib portion 115. For example, according to the difference the contraction force of an end 114b or 115b of an upper end of the outer barrier rib portion 114 or the dummy barrier rib portion 115 and the contraction force of other portion 114a or 115a of the upper end of the outer barrier rib portions 114 or the upper end of the dummy barrier rib portion 115, the end portion 114b or 115b rises abruptly.

As a result, the height of the end portion 114b or 115b of the outer barrier rib portion 114 or the dummy barrier rib portion 115 is higher than the height of other portion 114a or 115a, and thus the end portion 114b or 115b collides against the first substrate 101, which increases noise.

According to the conventional art, various methods have been developed to solve this problem.

For example, in Japanese Patent Publication No. Hei 03-217464, published on 31 Jul., 2003, a spacer is used inside barrier ribs and a sealing member in order to maintain the distance to a substrate. In Japanese Patent Publication No. Hei 06-114318, published on 27 Apr., 2006, a structure member is installed to regulate the size of a gap between upper and lower substrates.

However, when using a spacer as disclosed in Japanese Patent Publication No. Hei 03-217464 or a structure member as disclosed in Japanese Patent Publication No. Hei 06-114318, the manufacturing cost increases and the manufacturing process becomes complicated.

### SUMMARY OF THE INVENTION

The present invention provides a plasma display panel (PDP) having a dielectric layer with an improve structure in order to generate a gap between a substrate and barrier ribs, and thus to reduce noise.

According to an aspect of the present invention, there is provided a PDP comprising: a pair of substrates facing each other; a plurality of discharge electrodes disposed on inner surfaces of the substrates; a dielectric layer covering the discharge electrodes; and barrier ribs disposed between the substrates to form discharge spaces therebetween, wherein the substrates are partitioned into a display area displaying an image and a non-display area extended from the display area, and the barrier ribs include a plurality of first barrier ribs disposed in the display area and a plurality of second barrier ribs disposed in the non-display area, and the thickness of the dielectric layer in the non-display area in which the second barrier ribs are disposed is smaller than the thickness of the dielectric layer in the display area in which the first barrier ribs are disposed.

A gap may be formed between an upper end of the second barrier ribs and the substrate corresponding to the upper end of the second barrier ribs due to the difference in the thicknesses of the dielectric layer.

The gap may be formed in an area from a boundary between the display area and the non-display area to the non-display area.

The gap may be formed only in the non-display area corresponding to the second barrier ribs.

An upper end of the first barrier ribs and the substrate may contact each other so that no gap is formed therebetween.

The dielectric layer may include a first layer covering the discharge electrodes in the display area and the non-display area, and a second layer stacked on the first layer in the display area in which the first barrier ribs are disposed.

A phosphor layer may be coated in a discharge space partitioned by the first barrier ribs, and no phosphor layer may be coated in a space partitioned by the second barrier ribs.

According to another aspect of the present invention, there is provided a PDP comprising: a pair of substrates disposed to face each other and partitioned into a display area displaying images and a non-display area extended from the display area; a plurality of discharge electrodes disposed in the substrates; a dielectric layer covering the discharge electrodes; barrier ribs disposed between the substrates and including a plurality of first barrier ribs disposed in the display area and a plurality of second barrier ribs disposed in the non-display area; and a sealing member disposed between the substrates and sealing the substrates, wherein the thickness of the dielectric layer in the non-display area in which the second barrier ribs are disposed is smaller than the thickness of the dielectric layer in the display area in which the first barrier ribs are disposed.

A gap may be formed between an upper end of the second barrier ribs and the substrate corresponding thereto due to the difference in the thicknesses of the dielectric layer.

The height of the sealing member may be higher than the barrier ribs due to the thickness of the stepped dielectric layer.

The first barrier ribs may include a plurality of discharge barrier rib portions displaying an image by light emission of the phosphor layer, and the second barrier ribs may include a plurality of outer barrier rib portions connected in a single body to the outside of the discharge barrier rib portions, and a dummy barrier rib portion separated a predetermined distance from the outer barrier rib portions.

### BRIEF DESCRIPTION OF THE DRAWINGS

A more complete appreciation of the present invention, and many of the attendant advantages thereof, will become readily apparent as the same becomes better understood by reference to the following detailed description when considered in conjunction with the accompanying drawings in which like reference symbols indicate the same or similar components, wherein:

FIG. 1 is a cross-sectional view of a portion of a conventional plasma display panel (PDP);

FIG. 2 is a cross-sectional view of a portion of the PDP of FIG. 1, in which a dummy barrier rib portion or an outer barrier rib portion is installed;

FIG. 3 is a separate partial perspective view of a PDP according to an embodiment of the present invention;

FIG. 4 is a plane view of the arrangement of discharge electrodes and barrier ribs of FIG. 3;

FIG. 5 is a cross-sectional view of a portion of the PDP of FIG. 3, cut along a V-V line of FIG. 3;

FIG. 6 is an extended cross-sectional view of a portion A of FIG. 5;

FIG. 7 is a cross-sectional view of a portion of a PDP according to another embodiment of the present invention;

FIG. 8 is a cross-sectional view of a portion of a PDP according to another embodiment of the present invention;

FIG. 9 is a plane view of a discharge cell of the PDP of FIG. 8;

FIG. 10 is a cross-sectional view of a portion of a PDP according to another embodiment of the present invention;

FIG. 11 is a plane view of a discharge cell of the PDP of FIG. 10;

FIG. 12 is a cross-sectional view of a portion of a PDP according to another embodiment of the present invention;

FIG. 13 is a plane view of a discharge cell of the PDP of FIG. 12; and

FIG. 14 is a cross-sectional view of a portion of a PDP according to another embodiment of the present invention.

### DETAILED DESCRIPTION OF THE INVENTION

The present invention will now be described more fully with reference to the accompanying drawings, in which exemplary embodiments of the invention are shown.

FIG. 3 is a separate partial perspective view of a plasma display panel (PDP) 300 according to an embodiment of the present invention;

Referring to FIG. 3, the PDP 300 includes a first substrate 301 and a second substrate 302 disposed parallel to the first substrate 301.

The first substrate 310 and the second substrate 302 are encapsulated by a frit glass 319. The frit glass 319 is coated along edges of inner surfaces of the first substrate 310 and the second substrate 302 facing each other when the first substrate 310 and the second substrate 302 are combined. Thus, an inner space formed by the first substrate 310 and the second substrate 302 is hermetically sealed from the outside.

The first substrate 301 may be formed of a transparent substrate (e.g., a soda line glass), an opaque substrate, a colored glass, or a synthetic resin, etc.

Sustain discharge electrode pairs 305 including X electrodes 303, parallel to the X 13 direction of the PDP 300, and Y electrodes 304 are formed on the inner surface of the first substrate 301. The X electrodes 303 and the Y electrodes 304 are alternately arranged along the Y direction is of the first substrate 301, and one pair formed of the X electrode 303 and the Y electrode 304 is disposed in each discharge cell.

The X electrode 303 includes an X transparent electrode 306 formed on the inner surface of the first substrate 301 and an X bus electrode line 307 electrically connected to the X transparent electrode 306. The X transparent electrode 306 has a tetragonal cross-section and is disposed in each discharge cell, and the X bus electrode line 307 is disposed in stripes along the X direction of the first substrate 301.

The Y electrode 304 has a shape that is substantially symmetric to the X electrode 303, and includes a Y transparent electrode 308 formed on the inner surface of the first substrate 301 and a Y bus electrode line 309 electrically connected to the Y transparent electrode 308. The Y transparent electrode 308 has a tetragonal cross-section and is disposed in each discharge cell to face the X transparent electrode 306. The Y bus electrode line 309 is disposed in stripes along the X direction of the first substrate 301.

The X transparent electrode 306 and the Y transparent electrode 308 are formed of a transparent conductive layer, for example, an indium tin oxide (ITO) film, in order to increase the aperture of the first substrate 301. The X bus electrode line 307 and the Y bus electrode line 309 are formed of a metal having excellent conductivity, for example, Ag (silver) paste or a chromium-copper-chromium alloy.

A space between a pair of sustain discharge electrodes 305 and another pair of sustain discharge electrodes 305 adjacent thereto corresponds to a non-display area. An insulating black stripe layer may be further formed in the non-display area to increase image contrast.

The pairs of sustain discharge electrodes 305 are covered by a first dielectric layer 310 formed of a glass paste in which various fillers are mixed.

A protection layer 311 such as MgO (Magnesium Oxide, or Magnesia) is formed on the surface of the first dielectric layer 310 to prevent damage of the first dielectric layer 310 and to increase emission of second electrons.

The second substrate 302 may preferably be formed of substantially the same material as the first substrate 301, but may also be formed of a transparent glass, an opaque glass, a colored glass, or a synthetic resin, according to whether the PDP 300 is transmissive or reflective.

Address electrodes 312 are formed on the inner surface of the second substrate 302. The address electrodes 312 are disposed to cross the Y electrodes 304 and are covered by a second dielectric layer 313.

Also, barrier ribs 320 are formed between the first and second substrates 301 and 302 to partition discharge cells together with the first and second substrates 301 and 302. The barrier ribs 320 include a plurality of discharge barrier rib portions 321, a plurality of outer barrier rib portions 322 and 323 connected to the discharge barrier rib portions 321, and a dummy barrier rib portion 324 that is separated a predetermined distance from the outermost barrier rib portion 323.

The discharge barrier rib portions 321 and the outer barrier rib portions 322 and 323 include a first portion 315 in the direction crossing the address electrodes 312, and a second portion 316 in the direction parallel to the address electrodes 312. The combined first portion 315 and the second portion 316 partition a closed structure, for example, a matrix type discharge space.

Alternatively, the structure of the combined first portion 315 and the second portion 316 may be of a meander type, a delta type, a honeycomb type, etc. A discharge space partitioned by one of the above structures may also have another polygonal, circular, oval shape, but is not limited thereto.

The dummy barrier rib portion 324 is a striped structure disposed on the outer side of the outermost barrier rib portion 323, and has a larger width than the discharge barrier rib portion 321 or the outer barrier rib portions 322 and 323.

Although the barrier ribs 320 include the discharge barrier rib portions 321, the outer barrier rib portions 322 or 323, and the dummy barrier rib portion 324 according to the current embodiment of the present invention, the present invention is not limited thereto. Thus, the barrier ribs may have any structure as long as they include a discharge barrier rib portion partitioning a discharge space realizing an image during a discharge and a peripheral barrier rib portion disposed on the outer side of the discharge barrier rib portion.

* Meanwhile, a discharge gas such as Ne—Xe gas or He—Xe gas is injected into the discharge cells partitioned by the first substrate 301, the second substrate 302, and the barrier ribs 320.

Also, red, green, and blue phosphor layers 317 emitting visible light by being excited by ultraviolet rays generated by discharge gas are coated inside the discharge cells. The red, green, and blue phosphor layers 317 can be respectively coated in any area of the discharge cells; for example, in the current embodiment, the red, green, and blue phosphor layers 317 are coated in the entire discharge space partitioned by the discharge barrier rib portions 321. On the other hand, the red, green, and blue phosphor layers 317 are not coated in the space formed by the outer barrier rib portions 322 and 323, and the dummy barrier rib portion 324.

Also, the phosphor layers 317 include red, green, and blue phosphor layers; the red phosphor layer may preferably be formed of (Y,Gd)BO₃; Eu⁺³, the green phosphor layer may preferably be formed of Zn₂SiO₄:Mn²⁺, and the blue phosphor layer may preferably be formed of BaMgA₁₀O₁₇:Eu²⁺.

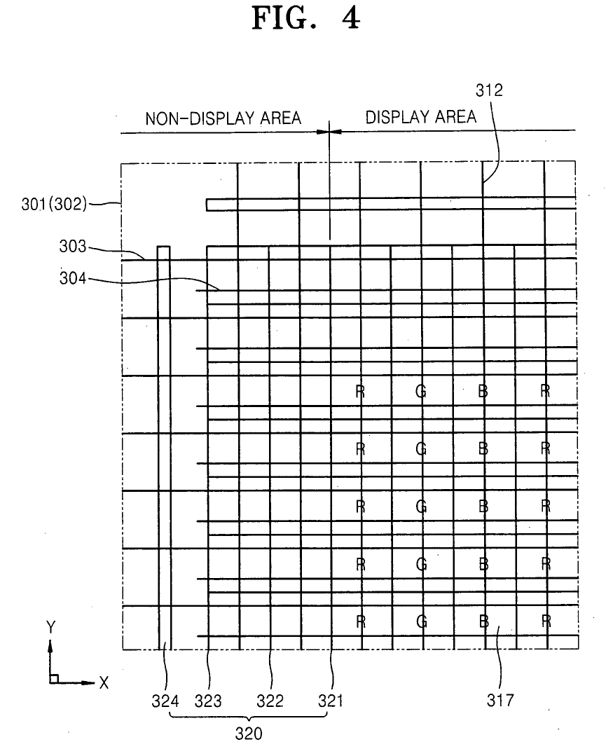

FIG. 4 illustrates the arrangement of the discharge electrodes 303, 304, and 312 and the barrier ribs 320.

Hereinafter, the same reference numerals like in the previous drawings denote like elements.

Referring to FIG. 4, the combined first substrate 301 and the second substrate 302 are partitioned into a display area displaying an image by a discharge generated in response to power applied to the discharge electrodes 303, 304, and address electrodes 312 and a non-display area extending along an edge of the display area so as to connect the discharge electrodes 303, 304, and address electrodes 312 to external terminals.

The barrier ribs 320 include a plurality of discharge barrier rib portions 321 arranged in the display area, outer barrier rib portions 322 and 323 connected to the outside of the discharge barrier rib portions 321 and arranged in the non-display area, and a dummy barrier rib portion 324 separated apart from the outermost barrier rib portion 323 and arranged in the non-display area.

The discharge barrier rib portions 321 partition a closed structure, for example, a matrix type discharge space. Red, green, and blue phosphor layers 317 emitting light during a discharge in order to realize images are coated in the discharge space formed by the discharge barrier rib portion 321.

The outer barrier rib portions 322 and 323 are connected as a single body with the discharge barrier rib portions 321 outside of the discharge barrier rib portions 321 in order to prevent deformation of the discharge barrier rib portions 321 when the barrier ribs 320 are patterned. No red, green, or blue phosphor layers 317 are coated in the space formed by the outer barrier rib portions 322 and 323.

The dummy barrier rib portion 324 is separated a predetermined distance from the outermost barrier rib portion 323 among the outer barrier rib portions 322 and 323, and has a larger width than the discharge barrier rib portions 321 or the outer barrier rib portions 322 and 323.

The X electrodes 303 and the Y electrodes 304 extend in the discharge space along the X direction of the PDP 300 from the display area to the non-display area, and face each other in each discharge space. The address electrodes 312 extend in the discharge space along the Y direction of the PDP 300 to cross the Y electrodes 304.

The first dielectric layer 310 (see FIG. 3) is formed to have different thicknesses in a portion corresponding to the display area and in a portion corresponding to the non-display area.

This will be described in more detail, hereinafter.

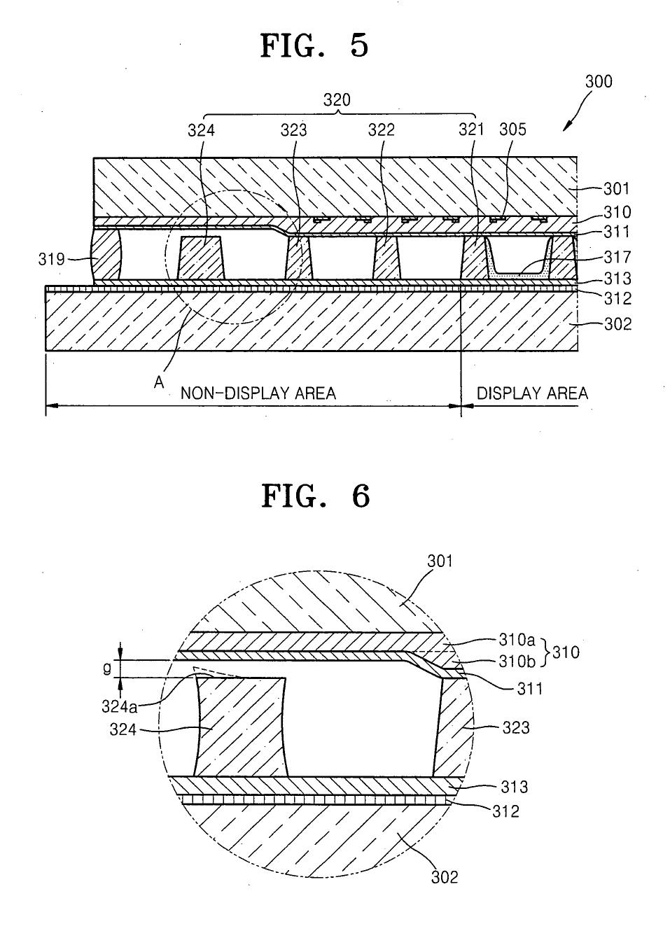

FIG. 5 is a cross-sectional view of a portion of the PDP 300 FIG. 3 cut along line V-V of FIG. 3, and FIG. 6 is an extended cross-sectional view of portion A of FIG. 5.

Referring to FIGS. 5 and 6, the discharge barrier rib portion 321 is disposed in the display area between the first substrate 301 and the second substrate 302, and a plurality of outer barrier rib portions 322 and 323 and a dummy barrier rib portion 324 separated from the outer barrier rib portions 322 and 323 are disposed in the non-display area. Meanwhile, a sealing member 319 is installed outside the dummy barrier rib portion 324.

Since the discharge barrier rib portion 321, the outer barrier rib portions 322 and 323, and the dummy barrier rib portion 324 are formed using the same barrier rib manufacturing process, they may preferably be formed to have the same height, and the dummy barrier rib portion 324 is formed to have a larger width than the discharge barrier rib portion 321 and the outer barrier rib portions 322 and 323.

A gap g is formed between the first substrate 301 and an upper end 324a of the dummy barrier rib portion 324. The gap g is formed such that the first dielectric layer 310 corresponding to the dummy barrier rib portion 324 in the non-display area has a step shape.

That is, a first layer 310a of the first dielectric layer 310 is formed on the inner surface of the first substrate 301 so as to cover the first discharge electrode 305. The first layer 310a is formed to have a uniform thickness over both the display area and the non-display area.

A second layer 310b is stacked on the surface of the first layer 310a. The second layer 310b may preferably be formed of substantially the same material as the first layer 310a. The second layer 310b is formed in an area corresponding to the display area and in areas of the non-display area corresponding to the discharge barrier rib portion 321 and the outer barrier rib portions 322 and 323.

Accordingly, the area where the dummy barrier rib portion 324 is disposed is a single-layer structure including the first layer 310a, whereas the area where the discharge barrier rib portion 321 and the outer barrier rib portions 322 and 323 are disposed is a two-layer structure including the first layer 310a and the second layer 310b stacked on the first layer 310a.

Thus, the thickness of the first dielectric layer 310 in the area where the dummy barrier rib portion 324 is disposed is smaller than the thickness of the first dielectric layer 310 in the area where the discharge barrier rib portion 321 and the outer barrier rib portions 322 and 323 are disposed. Accordingly, the gap g equal to the thickness of the second layer 310b is formed between the first substrate 301 and the upper end 324a of the dummy barrier rib portion 324 to the first substrate 301.

On the other hand, there is no gap between upper ends of the discharge barrier rib portion 321 and the outer barrier rib portions 322 and 323 and the first substrate 301. The outer barrier rib portions 322 and 323 are formed as a single body with the discharge barrier rib portion 321 outside of the discharge barrier rib portion 321, and may preferably have a symmetric vertical structure so as to minimize deformation during firing.

The sealing member 319 is formed to have a height higher than the discharge barrier rib portion 321, the outer barrier rib portions 322 and 323, and the dummy barrier rib portion 324, such that the sealing member 319 engages (contacts) second dielectric layer 313 and protection layer 311.

In the PDP 300 having the above-described structure, when barriers ribs are patterned, deformation is generated in the dummy barrier rib portion 324, and thus even if a portion of an end of the upper end 324a is deformed as denoted with a dotted line in FIG. 6, the gap g exists between the first substrate 301 and the upper end 324a of the dummy barrier rib portion 324 corresponding to the first substrate 301. Thus, the dummy barrier rib portion 324 does not collide against the first substrate 301 (or protection layer 311). Consequently, noise that might be generated during driving can be prevented.

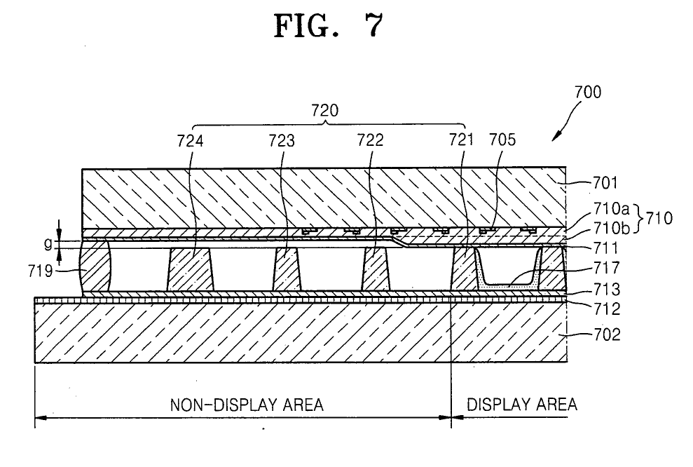

FIG. 7 is a PDP 700 according to another embodiment of the present invention.

Referring to FIG. 7, the PDP 700 includes a first substrate 701 and a second substrate 702, and a sealing member 719 is interposed between the first and second substrates 701 and 702 facing each other.

First discharge electrodes 705 are disposed on the inner surface of the first substrate 701, and the first discharge electrodes 705 are covered by a first dielectric layer 710, and a protection layer 711 is formed on the first dielectric layer 710. A second discharge electrode 712 is disposed on the inner surface of the second substrate 702, and the second discharge electrode 712 is covered by a second dielectric layer 713.

Barrier ribs 720 are disposed between the first substrate 701 and the second substrate 702. The barrier ribs 720 include a plurality of discharge barrier rib portion 721 disposed in the display area, a plurality of outer barrier rib portions 722 and 723 connected to the discharge barrier rib portion 721 and disposed in the non-display area, and a dummy barrier rib portion 724 disposed in the non-display area. Red, green, and blue phosphor layers 717 are formed in a discharge space partitioned by the discharge barrier rib portion 721. In a space partitioned by the outer barrier rib portion 722, no red, green, or blue phosphor layer 717 is formed. Meanwhile, a sealing member 719 is formed on the outside of the dummy barrier rib portion 724.

The first dielectric layer 710 includes a first layer 710a covering the first discharge electrode 705 and a second layer 710b stacked on the surface of the first layer 710a.

The first layer 710a is formed to have a uniform thickness over the display area and the non-display area. The second layer 710b is coated in the display area and in the portion of the display area near the boundary between the non-display area and the display area. In other words, the second layer 710b is not formed in the non-display area corresponding to the outer barrier rib portions 722 and 723 and the dummy barrier rib portion 724, and may preferably be formed of substantially the same material as the first layer 710a.

Accordingly, the thickness of the first dielectric layer 710 in the area where the outer barrier rib portions 722 and 723 and the dummy barrier rib portion 724 are formed is smaller than the thickness of the first dielectric layer 710 in the area where the discharge barrier rib portion 721 is formed. Accordingly, a gap g is formed between the first substrate 701 and upper ends of the outer barrier rib portions 722 and 723 and an upper end of the dummy barrier rib portion 724 corresponding to the first substrate 701. On the other hand, there is no gap between the first substrate 701 and an upper end of the discharge barrier rib portion 721 corresponding to the first substrate 701.

As described above, in the PDP 700, the first dielectric layer 710 formed of the first layer 710a and the second layer 710b, wherein the second layer 710b is stacked on the first layer 710a in the display area, and the first dielectric layer 710 formed of the first layer 710a, but not the second layer 710b, is formed in the non-display area, and thus the outer barrier rib portions 722 and 723 and the dummy barrier rib portion 724 do not contact the first substrate 701 or the protection layer 711 formed on the first substrate 701. The number of the outer barrier rib portions 722 and 723 and the dummy barrier rib portion 724 is not limited, and they may preferably be formed on all barrier ribs where collision with the first substrate 710 is expected.

Table 1 shows the measurements of noise according to experiments conducted by the inventor of the present invention.

TABLE 1

| | | Normal | | | | | | | |
|---|---|---|---|---|---|---|---|---|---|
| | | pressure | | | | | | | |
| | | (dB) | 1000 m | 1300 m | 1600 m | 2000 m | 2300 m | 2500 m | 2800 m |
| Comparison | No. 1 | 21.7 | 25.4 | 26.5 | 27.7 | 29.9 | 32.0 | 33.8 | 40.1 |
| Example | No. 2 | 22.1 | 26.4 | 27.6 | 29.1 | 32.1 | 38.3 | 42.0 | 45.8 |
| | No. 3 | 21.9 | 25.9 | 27.0 | 28.4 | 31.0 | 35.1 | 37.9 | 42.9 |
| | No. 4 | 22.5 | 29.1 | 32.3 | 36.6 | 44.5 | 47.1 | 48.0 | 49.7 |
| | No. 5 | 24.2 | 27.8 | 28.8 | 30.1 | 32.1 | 34.4 | 36.2 | 40.8 |
| | No. 6 | 22.8 | 24.0 | 25.6 | 28.1 | 32.6 | 37.2 | 39.9 | 41.1 |
| | average | 22.5 | 26.5 | 28.0 | 30.0 | 33.7 | 37.4 | 39.6 | 43.4 |
| Embodiment | No. 1 | 18.1 | 19.2 | 19.4 | 19.7 | 20.2 | 20.6 | 21.2 | 21.8 |
| | No. 2 | 19.1 | 20.9 | 21.3 | 21.6 | 21.7 | 22.2 | 22.3 | 22.5 |
| | No. 3 | 18.5 | 19.6 | 19.9 | 20.3 | 20.5 | 20.6 | 20.7 | 20.8 |
| | No. 4 | 17.0 | 18.0 | 18.3 | 18.7 | 19.1 | 19.6 | 20.0 | 20.4 |
| | No. 5 | 17.7 | 18.4 | 18.6 | 18.6 | 19.0 | 19.6 | 19.8 | 20.2 |
| | No. 6 | 18.0 | 19.5 | 19.9 | 20.2 | 20.7 | 21.3 | 21.5 | 21.7 |
| | average | 18.1 | 19.2 | 19.6 | 19.9 | 20.2 | 20.6 | 20.9 | 21.2 |

Noise was measured in an anechoic, decompressed chamber. The measuring position was changed from one height to another height by reducing the chamber's pressure. The comparison example is a PDP in which no gap is formed between the outer barrier rib portions and the dummy barrier rib portion disposed in the non-display area and a substrate corresponding to them. In the PDP according to the present invention, a gap is formed between the outer barrier rib portion and the dummy barrier rib portion and the substrate corresponding to them.

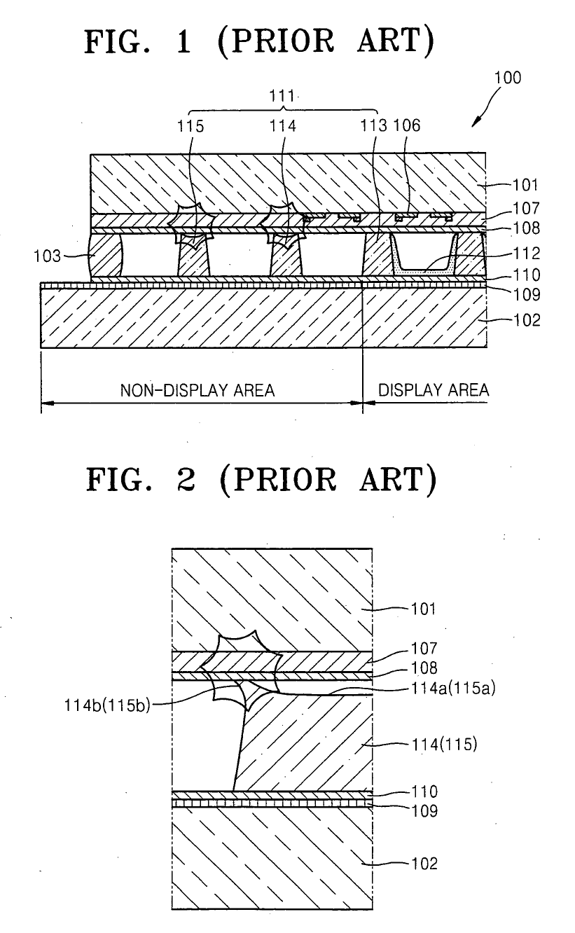

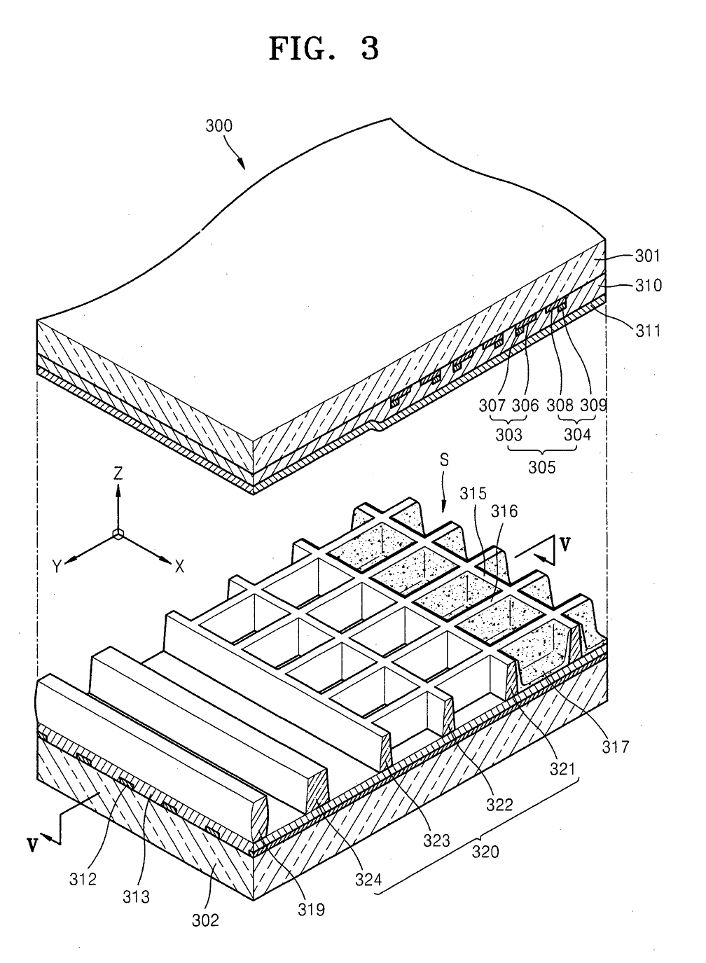

Referring to FIG. 1, in the case of the comparison example, the average normal pressure was 22.5 dB, 26.5 dB, 28.0 dB, 30.0 dB, 33.7 dB, 37.4 dB, 39.6 dB, 43.4 dB at 1000 m, 1300 m, 1600 m, 2000 m, 2300 m, 2500 m, 2800 m, respectively, while in the case of the inventive embodiment, the average normal pressure was 18.1 dB, 19.2 dB, 19.6 dB, 19.9 dB, 20.2 dB, 20.6 dB, 20.9 dB, 21.2 dB at each height, which denotes that noise is reduced significantly. Also, vibration of the PDP is decreased in the high grounds as the pressure difference between the inside and outside of the PDP is decreased, and thus the amount of noise is decreased.

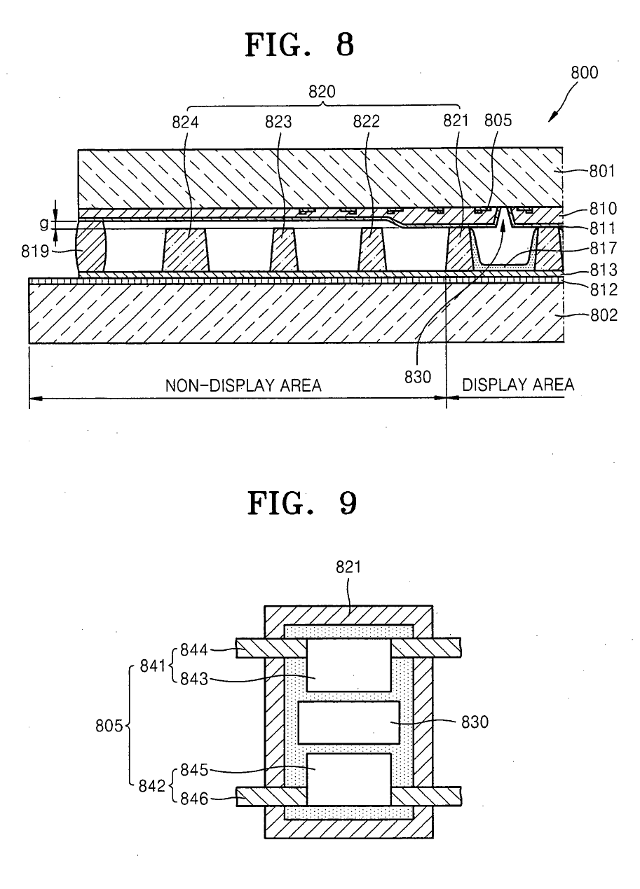

FIG. 8 is a cross-sectional view of a portion of a PDP 800 according to another embodiment of the present invention, and FIG. 9 is a plane view of a discharge cell of the PDP 800 of FIG. 8.

Referring to FIG. 8, the PDP 800 includes a first substrate 801 and a second substrate 802 facing the first substrate 801. A sealing member 819 is interposed between the first and second substrates 801 and 802, on the edges of the first and second substrates 801 and 802 facing each other.

First discharge electrodes 805 are disposed on the inner surface of the first substrate 801, and the first discharge electrodes 805 are covered by a first dielectric layer 810, and a protection layer 811 is formed on the surface of the first dielectric layer 810. A second discharge electrode 812 is disposed on the inner surface of the second substrate 802, and the second discharge electrode 812 is covered by the second dielectric layer 813.

Barrier ribs 820 are disposed between the first substrate 801 and the second substrate 802. The barrier ribs 820 include a plurality of discharge barrier rib portions 821 disposed in the display area, a plurality of outer barrier rib portions 822 and 823 connected to the discharge barrier rib portion 821 and disposed in the non-display area, and a dummy barrier rib portion 824 disposed in the non-display area. In a discharge space partitioned by the discharge barrier rib portion 821, red, green, and blue phosphor layers 817 are formed. In a space partitioned by the outer barrier rib portions 822 and 823, no red, green, or blue phosphor layer 817 is formed.

The first discharge electrodes 805 are pairs of sustaining discharge electrodes having X electrodes 841 and Y electrodes 842; one pair of the first discharge electrode 805 is disposed in each discharge cell. The X electrode 841 includes an X transparent electrode 843 and an X bus electrode line 844 electrically connected to the X transparent electrode 843, and the Y electrode 842 includes an Y transparent electrode 845 and a Y bus electrode line 846 electrically connected to the Y transparent electrode 845. The second discharge electrode 812 is an address electrode disposed to cross the Y electrode 842.

An electric field focusing unit 830 is formed in a discharge gap between the X electrode 841 and the Y electrode 842 in order to facilitate discharge diffusion. The electric field focusing unit 830 can be formed by forming the area where the first dielectric layer 810 between the X electrode 841 and the Y electrode 842 is formed to be thinner than other areas or by not forming the first dielectric layer 810, and can reduce the increase of the discharge firing voltage.

The thickness of the first dielectric layer 810 in the non-display area where the outer barrier rib portions 822 and 823 and the dummy barrier rib portion 824 are disposed is smaller than the thickness of the first dielectric layer 810 in the display area where the discharge barrier rib portion 821 is formed. Consequently, a gap g is formed between an upper end of the outer barrier rib portion 822 and 823 and an upper end of the dummy barrier rib portion 824 and the first substrate 801 corresponding to them.

As described above, in the PDP 800 in which the electric field focusing unit 830 is formed, since the outer barrier rib portions 822 and 823 form a gap g with the first substrate 810 due to the difference in the thicknesses of the first dielectric layer 810, no collision is caused during driving, thereby decreasing noise.

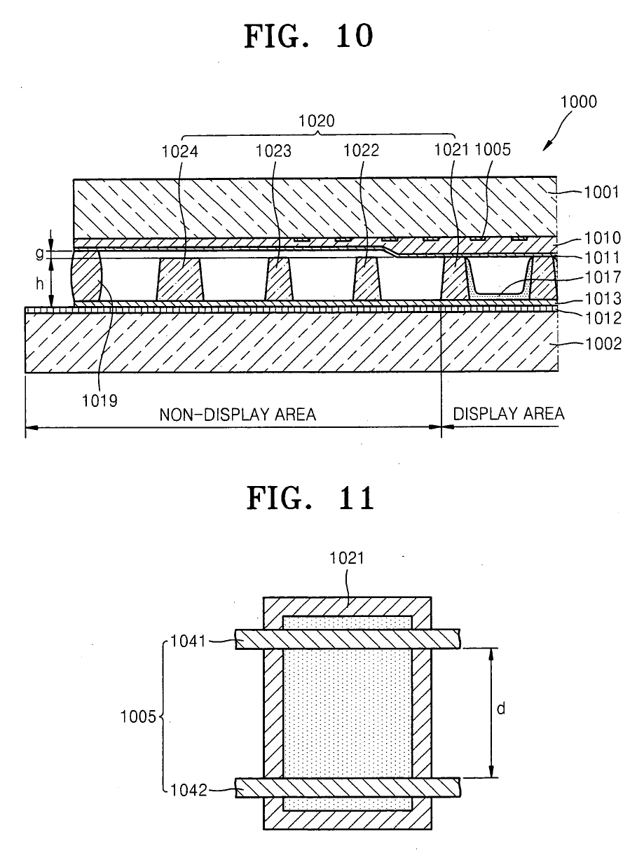

FIG. 10 is a cross-sectional view of a portion of a PDP 1000 according to another embodiment of the present invention, and FIG. 11 is a plane view of a discharge cell of the PDP 1000 of FIG. 10.

Referring to FIGS. 10 and 11, the PDP 1000 includes a first substrate 1001 and a second substrate 1002 facing the first substrate 1001. A sealing member 1019 is interposed between the first and second substrates 1001 and 1002, on the edges of the first and second substrates 1001 and 1002 facing each other.

First discharge electrodes 1005 are disposed on the inner surface of the first substrate 1001, and the first discharge electrodes 1005 are covered by a first dielectric layer 1010, and a protection layer 1011 is formed on the surface of the first dielectric layer 1010. A second discharge electrode 1012 is disposed on the inner surface of the second substrate 1002, and the second discharge electrode 1012 is covered by a second dielectric layer 1013.

Barrier ribs 1020 are disposed between the first substrate 1001 and the second substrate 1002. The barrier ribs 1020 include a discharge barrier rib portion 1021 disposed in the display area, a plurality of outer barrier rib portions 1022 and 1023 connected to the discharge barrier rib portion 1021 and disposed in the non-display area, and a dummy barrier rib portion 1024 disposed in the outside of the outermost barrier rib portion 1023 and disposed in the non-display area. Red, green, and blue phosphor layers 1017 are formed in a discharge space partitioned by the discharge barrier rib portion 1021. No red, green, or blue phosphor layer 1017 is formed in a space partitioned by the outer barrier rib portion 1022 and 1023.

The first discharge electrodes 1005 are pairs of sustaining discharge electrodes having X electrodes 1041 and Y electrodes 1042, wherein one pair of the first discharge electrode 1005 is disposed in each discharge cell. The second discharge electrode 1012 is an address electrode disposed to cross the Y electrode 1042.

The PDP 1000 has increased efficiency by using light emission in a positive column area as the X electrodes 1041 and the Y electrodes 1042 are formed at a large distance, unlike in the conventional art. A large distance between electrodes means that a distance d of a discharge gap between the X electrodes 1041 and the Y electrodes 1042 is larger than the total of the heights h of the barrier ribs 1020 and the second dielectric layer 1013.

According to the current embodiment of the present invention, the distance d of the discharge gap between the X electrode 1041 and the Y electrode 1042 is 440 micrometers, and the total of the heights h of the barrier ribs 1020 and the second dielectric layer 1013 is 125 micrometers. These measurements may vary according to the size of the PDP 100 and waveforms applied to the electrodes.

In the PDP 1000 having the above-described structure, when an address voltage is applied between the address electrode 1012 and the Y electrode 1042, wall charges are accumulated on the first dielectric layer 1010 covering the first discharge electrode 1005 as the result of address discharge and thus a predetermined discharge cell is selected.

Next, when a discharge sustaining voltage is applied between the Y electrode 1042 and the X electrode 1041 of the selected discharge cell, a negative electric field is applied between the Y electrode 1042 and the address electrode 1012 or between the X electrode 1041 and the address electrode 1012, and thus discharge is started, and the discharge is diffused along the address electrode 1012. Thus, finally, a main discharge is generated for a long period of time in a positive column between the Y electrode 1042 and the X electrode 1041 having a long gap.

Here, vacuum ultraviolet rays are emitted from excitation atoms of Xe generated during plasma discharge, and the vacuum ultraviolet rays excite the phosphor layer 1017 of the discharge cell and thus convert visible light, to display colors.

The thickness of the first dielectric layer 1010 in the non-display area where the outer barrier rib portions 1022 and 1023 and the dummy barrier rib portion 1024 are disposed is smaller than the thickness of the first dielectric layer 1010 in the display area where the discharge barrier rib portion 1021 is disposed.

Accordingly, a gap g is formed between an upper end of the outer barrier rib portions 1022 and 1023 and an upper end of the dummy barrier rib portion 1024, and the first substrate 1001 corresponding to them, and thus noise during driving can be reduced. The number of the outer barrier rib portions 1022 and 1023 and the dummy barrier rib portion 1024 is not limited, and they may preferably be formed on all barrier ribs where collision with the first substrate 1001 is expected.

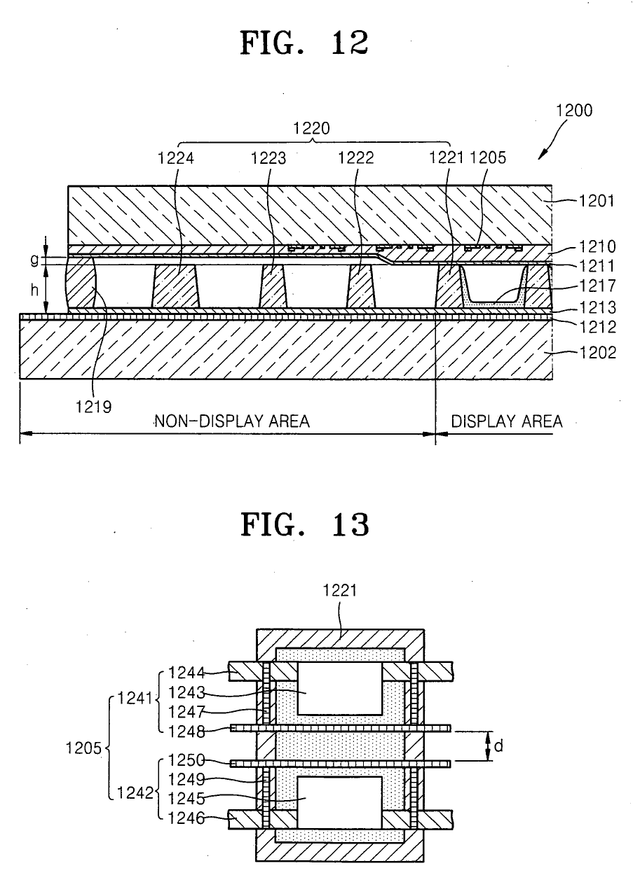

FIG. 12 is a cross-sectional view of a portion of a PDP 1200 according to another embodiment of the present invention, and FIG. 13 is a plane view of a discharge cell of the PDP 1200 of FIG. 12.

Referring to FIGS. 12 and 13, the PDP 1200 includes a first substrate 1201 and a second substrate 1202, and a sealing member 1219 interposed therebetween.

First discharge electrodes 1205 are disposed on the inner surface of the first substrate 1201, and the first discharge electrode 1205 are covered by a first dielectric layer 1210, and a protection layer 1211 is formed on the surface of the first dielectric layer 1210. A second discharge electrode 1212 is disposed on the inner surface of the second substrate 1202, and the second discharge electrode 1212 is covered by a second dielectric layer 1213.

Barrier ribs 1220 are disposed between the first substrate 1201 and the second substrate 1202. The barrier ribs 1220 include a plurality of discharge barrier rib portion 1221 disposed in the display area, a plurality of outer barrier rib portions 1222 and 1223 connected to the discharge barrier rib portion 1221 and disposed in the non-display area, and a dummy barrier rib portion 1224 separated apart from the outermost barrier rib portion 1223. Red, green, and blue phosphor layers 1217 are formed in a discharge space partitioned by the discharge barrier rib portion 1221. No red, green, or blue phosphor layer 1217 is formed in a space partitioned by the outer barrier rib portions 1222 and 1223 and dummy barrier rib portion 1224.

The first discharge electrodes 1205 are pairs of sustaining discharge electrodes having X electrodes 1241 and Y electrodes 1242, wherein one pair of the first discharge electrodes 1205 is disposed in each discharge cell. The X electrode 1241 includes an X transparent electrode 1243 and is an X bus electrode line 1244 electrically connected to the X transparent electrode 1243, and the Y electrode 1242 includes an Y transparent electrode 1245 and a Y bus electrode line 1246 electrically connected to the Y transparent electrode 1245. The second discharge electrode 1212 is an address electrode disposed to cross the Y electrode 1242.

An igniter electrode portion is formed in the X electrode 1241 and the Y electrode 1242 in order to obtain address driving at a low voltage and a low discharge firing voltage.

That is, a plurality of X bridge portions 1247 are drawn out on the barrier ribs 1220 from the X bus electrode line 1244 in a perpendicular direction to the X bus electrode line 1244, and an X igniter electrode portion 1248 in the form of a strip is formed in the center of the discharge cell in the same direction as the X bus electrode line 1244 at an end of the X bridge portions 1247. The X bridge portion 1247 and the X igniter electrode portion 1248 are formed of the same material, and may preferably be formed as transparent electrodes in order to prevent decrease of an aperture.

Also, in the case of the Y electrode 1242, Y bridge portions 1249 are formed symmetrically to the X electrode 1241 and a Y igniter electrode portion 1250 is disposed in the center of the discharge cell. The Y bridge portions 1249 and the Y igniter electrode portion 1250 are formed of the same transparent material.

As described above, as the X igniter electrode portion 1248 and the Y igniter electrode portion 1250 having a small line width are disposed in the center portion of the discharge cell, a distance d of the discharge gap is narrowed, thereby increasing discharge efficiency.

The thickness of the first dielectric layer 1210 in the non-display area where the outer barrier rib portions 1222 and 1223 are disposed is smaller than the thickness of the first dielectric layer 1210 in the display area where the discharge barrier rib portion 1221 is disposed. Accordingly, a gap g is formed between an upper end of the outer barrier rib portions 1222 and 1223 and an upper end of the dummy barrier rib portion 1224, and the first substrate 1201 corresponding to them.

As described above, in the PDP 1200 having the igniter electrode portion, the upper end of the outer barrier rib portions 1222 and 1223 and the upper end of the dummy barrier ribs 1224 form a gap with respect to the first substrate 1201 due to a step of the first dielectric layer 1210, and thus noise generated during driving can be reduced.

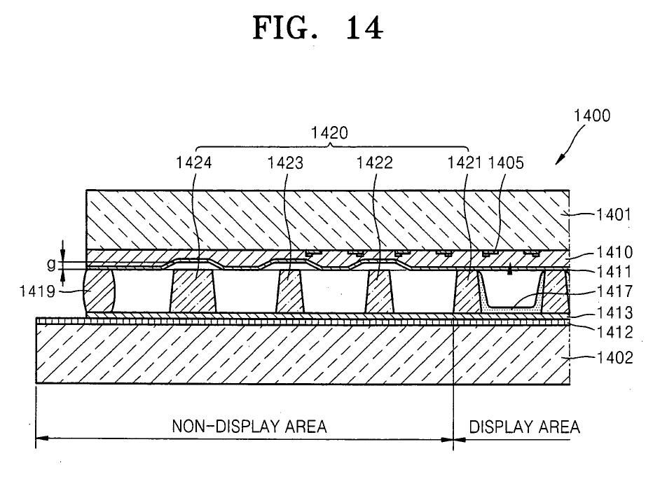

FIG. 14 is a cross-sectional view of a portion of a PDP 1400 according to another embodiment of the present invention.

Referring to FIG. 14, the PDP 1400 includes a first substrate 1401 and a second substrate 1402, and a sealing member 1419 interposed therebetween.

First discharge electrodes 1405 are disposed on the inner surface of the first substrate 1401, and the first discharge electrodes 1405 are covered by a first dielectric layer 1410, and a protection layer 1411 is formed on the surface of the first dielectric layer 1410. A second discharge electrode 1412 is disposed on the inner surface of the second substrate 1402, and the second discharge electrode 1412 is covered by a second dielectric layer 1413.

Barrier ribs 1420 are disposed between the first substrate 1401 and the second substrate 1402. The barrier ribs 1420 include a discharge barrier rib portion 1421, outer barrier rib portions 1422 and 1423 connected to the discharge barrier rib portion 1421, and a dummy barrier rib portion 1424 separated apart from the outermost barrier rib portion 1423. The discharge barrier rib portion 1421, the outer barrier rib portions 1422 and 1423, and the dummy barrier rib portion 1424 may have other shapes different from those shown in the drawing.

Meanwhile, red, green, and blue phosphor layers 1417 are formed in a discharge space partitioned by the discharge barrier rib portion 1421, and no phosphor layer 1417 is formed in a space partitioned by the outer barrier rib portions 1422 and 1423.

Here, unlike in the previously described embodiments, the first dielectric layer 1410 according to the current embodiment has different thicknesses only in the area corresponding to the outer barrier rib portions 1422 and 1423 and the dummy barrier rib portion 1424.

That is, the thickness of the first dielectric layer 1410 in the non-display area to which the outer barrier rib portions 1422 and 1423 and the dummy barrier rib portion 1424 correspond is smaller than the thickness of the first dielectric layer 1410 in the display area where the discharge barrier rib portion 1421 or the thickness of the first dielectric layer 1410 in the non-display area where the outer barrier rib portions 1422 and 1423 and the dummy barrier ribs 1424 are not disposed. Accordingly, a gap g is formed only between an upper end of the outer barrier ribs 1422 and 1423 and an upper end of the dummy barrier rib portion 1424, and the first substrate 1201 corresponding to them.

As described above, the PDP according to the present invention has the following advantages.

First, since a gap is formed between a substrate and barrier ribs disposed in a non-display area, the substrate and the barrier ribs do not collide each other. Accordingly, noise can be reduced.

Second, as the noise of the PDP is reduced, stability of a discharge during driving can be achieved.

Third, assembly adhesion of the PDP can be significantly increased.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A plasma display panel (PDP) comprising:
a pair of substrates facing each other;
a plurality of discharge electrodes disposed on inner surfaces of the substrates;
dielectric layers covering the discharge electrodes; and
barrier ribs disposed between the substrates to form discharge spaces therebetween, wherein the substrates are partitioned into a display area displaying an image and a non-display area extended from the display area, and
the barrier ribs include a plurality of first barrier ribs disposed in the display area and a plurality of second barrier ribs disposed in the non-display area, and the thickness of the dielectric layer in the non-display area in which the second barrier ribs are disposed is smaller than the thickness of the dielectric layer in the display area in which the first barrier ribs are disposed.

2. The plasma display panel (PDP) of claim 1, wherein a gap is formed between an upper end of the second barrier ribs and the substrate corresponding to the upper end of the second barrier ribs due to the difference in the thicknesses of the dielectric layer.

3. The plasma display panel (PDP) of claim 2, wherein the gap is formed in an area from a boundary between the display area and the non-display area to the non-display area.

4. The plasma display panel (PDP) of claim 2, wherein the gap is formed only in the non-display area corresponding to the second barrier ribs.

5. The plasma display panel (PDP) of claim 2, wherein an upper end of the first barrier ribs and the substrate contact each other so that no gap is formed therebetween.

6. The plasma display panel (PDP) of claim 1, wherein the dielectric layer includes a first layer covering the discharge electrodes in the display area and the non-display area, and a second layer stacked on the first layer only in the display area in which the first barrier ribs are disposed.

7. The plasma display panel (PDP) of claim 1, wherein a phosphor layer is coated in a discharge space partitioned by the first barrier ribs, and no phosphor layer is coated in a space partitioned by the second barrier ribs.

8. A plasma display panel (PDP) comprising:
a pair of substrates disposed to face each other and partitioned into a display area displaying images and a non-display area extended from the display area;
a plurality of discharge electrodes disposed in the substrates;
dielectric layers covering the discharge electrodes;
barrier ribs disposed between the substrates and including a plurality of first barrier ribs disposed in the display area and a plurality of second barrier ribs disposed in the non-display area; and
a sealing member disposed between the substrates and sealing the substrates, wherein the thickness of the dielectric layer in the non-display area in which the second barrier ribs are disposed is smaller than the thickness of the dielectric layer in the display area in which the first barrier ribs are disposed.

9. The plasma display panel (PDP) of claim 8, wherein a gap is formed between an upper end of the second barrier ribs and the substrate corresponding thereto due to the difference in the thicknesses of the dielectric layer.

10. The plasma display panel (PDP) of claim 9, wherein the dielectric layer is thinly formed over an area from a boundary between the display area and the non-display area to the non-display area.

11. The plasma display panel (PDP) of claim 9, wherein the dielectric layer is thinly formed only in the non-display area corresponding to the second barrier ribs.

12. The plasma display panel (PDP) of claim 8, wherein an upper end of the first barrier ribs and the substrate corresponding thereto are disposed to contact each other so that no gap is formed therebetween.

13. The plasma display panel (PDP) of claim 8, wherein the first barrier ribs and the second barrier ribs have the same height.

14. The plasma display panel (PDP) of claim 8, wherein the height of the sealing member is higher than the barrier ribs due to the thickness of the stepped dielectric layer.

15. The plasma display panel (PDP) of claim 8, wherein the dielectric layer includes a first layer covering the discharge electrodes in the display area and the non-display area, and a second layer stacked on the first layer in the display area in which the first barrier ribs are disposed.

16. The plasma display panel (PDP) of claim 8, wherein a phosphor layer is coated in a discharge space partitioned by the first barrier ribs, and no phosphor layer is coated in a space partitioned by the second barrier ribs.

17. The plasma display panel (PDP) of claim 16, wherein the first barrier ribs include a plurality of discharge barrier rib portions displaying an image by light emission of the phosphor layer, and the second barrier ribs include a plurality of outer barrier rib portions connected in a single body to the outside of the discharge barrier rib portions, and a dummy barrier rib portion separated a predetermined distance from the outer barrier rib portions.

18. The plasma display panel (PDP) of claim 17, wherein the discharge barrier rib portions have a closed structure.

19. A plasma display panel (PDP) having first and second substrates disposed to face each other and partitioned into a display area displaying images and a non-display area extended from the display area, a plurality of discharge electrodes disposed in the substrates, a dielectric layer covering the discharge electrodes, barrier ribs disposed between the first and second substrates, and including a plurality of first barrier ribs disposed in the display area and a plurality of second barrier ribs disposed in the non-display area, and a sealing member disposed between the substrates and sealing the substrates, said plasma display panel comprising:
said first and second barrier ribs being in contact with said second dielectric layer;
said first barrier ribs being contact said first dielectric layer; and
said second barrier ribs not being in contact with said first dielectric layer.
